(19) United States
(12) Patent Application Publication
(10) Pub. No.: US 2013/0246975 A1
(43) Pub. Date: Sep. 19, 2013

(54) GESTURE GROUP SELECTION

(71) Applicants: Chandar Kumar Oddiraju, Santa Clara, CA (US); Richard James Lawson, Santa Clara, CA (US)

(72) Inventors: Chandar Kumar Oddiraju, Santa Clara, CA (US); Richard James Lawson, Santa Clara, CA (US)

(21) Appl. No.: 13/420,782

(22) Filed: Mar. 15, 2012

(51) Int. Cl. G06F 3/048; G06F 3/041

(52) U.S. Cl. 715/835

(57) ABSTRACT

Embodiments disclosed herein relate to gesture group selection. In one embodiment, a group selection of an icon is determined based on a direction, duration, and distance of a user gesture relative to a selected icon. The selected icon may be added to a group of selected icons. An operation may be performed on the group of selected icons.

### BACKGROUND

A user may interact with an electronic device using touch or gesture input. For example, an electronic device may include a camera for interpreting gestures relative to a display, or a display may include resistors to detect a touch to the display. Touch and gesture displays may allow for a user to interact with the electronic device without the use of a peripheral device, such as a keyboard.

### BRIEF DESCRIPTION OF THE DRAWINGS

The drawings describe example embodiments. The following detailed description references the drawings, wherein:

FIG. 1 is a block diagram illustrating one example of an apparatus.

FIG. 2 is a flow chart illustrating one example of a method to determine a group selection based on gesture input.

FIG. 3 is a diagram illustrating one example of determining a group selection based on gesture input.

### DETAILED DESCRIPTION

Multiple items may be selected on a user interface such that an operation may be performed on the group of selected items. In one implementation, gesture input is used to select a group of contiguous or non-contiguous icons to be operated upon as a group. An icon may be selected, such as with a touch or pose, and the duration, distance, and direction of a gesture input relative to the selected icon may be evaluated to determine whether the gesture indicates the selected icon is to be added to a group selection. For example, a downward motion of more than one cm with a time delay of between five and ten seconds from the beginning of the gesture to the end of the gesture may indicate a group selection of an identified icon. Using the direction, duration, and distance of a gesture input may allow a single type of input to be used to add an icon to a group selection, such as without the use of a keyboard and mouse. Existing operating system functionality may be leveraged to perform an operation on the group of icons. For example, the group of icons selected with the gesture input may be passed to an operating system method for performing an operation, such as a copy or delete operation, on the group of selected icons.

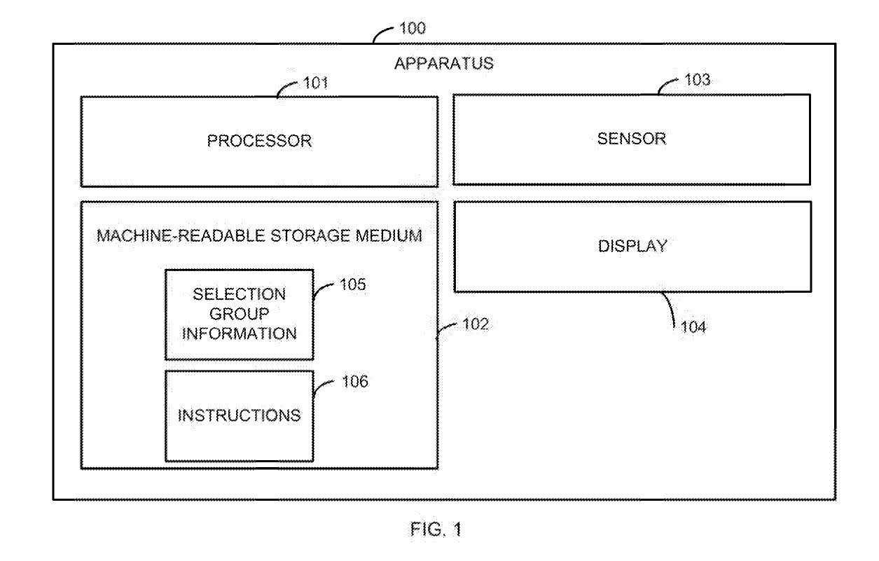

FIG. 1 is a block diagram illustrating one example of an apparatus 100. The apparatus may receive gesture input from a user and determine a group of selection items displayed on a user interface based on the gesture input. The apparatus 100 may be, for example, a laptop, slate, or mobile computing device. The apparatus 100 may include a processor 101, a machine-readable storage medium 102, a sensor 103, and a display 104.

The display 104 may be a display to display content to a user. The display 104 may be a screen of a computing, device, such as a mobile phone screen. The display 104 may be a television display or a large display for presentations. In one implementation, the display 104 is a screen upon which a user interface is projected. A user may interact with the display 104 to provide user input to the apparatus 100. For example, a user may touch the display 104 or gesture in front of the display 104.

The sensor 103 may be a sensor for sensing user input relative to the display 104. For example, the sensor 103 may be a sensor for sensing input without the use of a peripheral device, such as a keyboard. The sensor 103 may sense touch and gesture input The input may be from a user hand or a user holding a stylus or control. In some implementations, the apparatus 100 includes a first sensor that senses touch input and a sensor that senses gesture input. The sensor 103 may be, for example, an optical, capacitive, or resistive sensor for sensing touch or gesture input relative to the display 104.

The processor 101 may be any suitable processor, such as a central processing unit (CPU), a semiconductor-based microprocessor, or any other device suitable for retrieval and execution of instructions. In one embodiment, the apparatus 100 includes logic instead of or in addition to the processor 101. As an alternative or in addition to fetching, decoding, and executing instructions, the processor 101 may include one or more integrated circuits (ICs) or other electronic circuits that comprise a plurality of electronic components for performing the functionality described below. In one implementation, the apparatus 100 includes multiple processors. For example, one processor may perform some functionality and another processor may perform other functionality.

The machine-readable storage medium 102 may be any suitable machine readable medium, such as an electronic, magnetic, optical, or other physical storage device that stores executable instructions or other data (e.g., a hard disk drive, random access memory, flash memory, etc.). The machine-readable storage medium 102 may be, for example, a computer readable non-transitory medium.

The machine-readable storage 102 may include selection group information 105 and instructions 106. The instructions 106 and selection group information 105 may be included in the same or separate storages. The selection group information 105 may include information about items selected on the display 104. A user may select a group of items shown on the display 104. The display 104 may show a desktop user interface to allow a user to navigate to applications, documents, photographs, and other information stored on the apparatus 100. For example, the display 104 may show icons representing folders, programs, and saved items. A group of the icons may be selected such that an operation may be performed on the group of icons together. The selection group information 105 may include information about items on the display 104 selected within the selection group, and additional items may be added to the selection group. When an operation is selected, such as a copy or move operation, it may be performed on the items in the selection group as a whole.

The instructions 106 may include instructions executable by the processor 101 to add an item shown on the display 104 to the selection group. The instructions 106 may include instructions to determine to add an item based on a user selection of an item on the display 104 and a user movement corresponding to a movement of the item on the display 104. The user may indentify the item based on a touch or pose in front of the display 104. A user gesture, such as a movement in front of the display 104 or a touch across the display 104, may indicate a movement of the item, and the determination whether to add the item to the selection group 105 may be based on a distance, direction, and duration of a movement of the item. For example, a user may point to an icon and then move his finger downward for more than 10 mm for more than 2 seconds may indicate that the selected item is to be added to the selection group.

As an example, a user may touch a first icon displayed on the display 104 and move the icon across the display 104 by moving a finger touching the icon on the display 104. The distance, direction, and duration of the movement may indicate a group selection, and the first icon may be added to the selection group. The user may then touch a second icon on the display 104 and move a finger touching the icon across the display in a gesture with a duration, distance, and direction indicating a group selection. The second icon may be added to the selection group. The user may then select an option to delete, indicating that the items within the selection group are to be deleted.

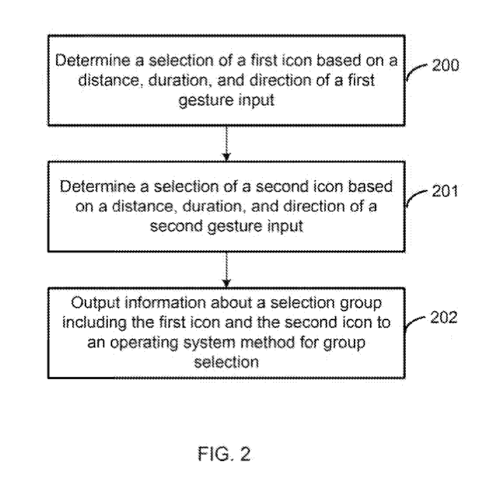

FIG. 2 is a flow chart illustrating one example of a method to determine a group selection based on gesture input. An electronic device may allow an operation to be performed more efficiently such that it may be performed on multiple items at the same time. For example, multiple documents in a folder may be selected for deletion using gesture input. The direction, duration, and distance of the gesture input may be evaluated to determine whether it indicates that a selected item is to be added to a selection group. Existing operating system functionality may be used to perform an operation on the items within the group selection. The method may be implemented, for example, by the apparatus 100.

Beginning at 200, a processor determines a selection of a first icon based on a distance, duration, and direction of a first gesture input. The icon may be any suitable item displayed on a display device, such as an item representing an application, document, or photograph. The icon may include a picture, representation, or a title.

The selection of the first icon may involve a user identifying the first icon on a display. For example, a user may touch the icon or point to the icon. In one implementation, the user may use a voice command to identify the icon.

The user may then perform a dragging gesture motion indicating that the selected icon is to be added to a group selection. The determination may be based on the distance, duration, and direction of the dragging motion. The icon may appear to drag across the display according to the gesture or may remain stationary as the user performs the gesture.

The distance criteria may be a distance that the icon is moved across the display, which may correlate to a user gesture movement. For example, a drag distance greater than a particular distance may indicate that an icon may be selected for group selection. In one implementation, a drag distance greater than a particular distance is not classified as a group selection.

The gesture direction may also be evaluated. For example, dragging the icon in different directions may have different meanings. In one implementation, dragging the icon downward towards the ground or towards the bottom of the display indicates that the icon is selected for group selection. In some implementations, dragging the icon in more than one direction may indicate a selection, such as where the icon moves in a circle or other motion.

The duration of the dragging movement may be considered. The length of time from the beginning of the movement to the end of the movement may differentiate different meanings of the movement. The beginning and end of the movement may be determined in any suitable manner. As an example, a dragging movement for a period of time shorter than a threshold may not be considered a selection. In one implementation, dragging the icon for an amount of time greater than a threshold indicates that the icon is not selected for group selection.

The drag, distance, and duration may be evaluated when the user ends the gesture. For example, a user may stop touching the display or may move a hand down to indicate that the movement is complete. The icon may no longer appear to drag across the display and may change appearance to indicate that it is part of a group selection. The icon may appear to move across the display as the user performs the gesture. In some implementations, the icon appears differently as it moves to indicate that it is being selected. The processor may cause a sound or other indication to alert a user that the selection is performed.

Continuing to 201, processor determines a selection of a second icon based on a distance, duration, and direction of a second gesture input. The user may begin a new gesture to identify the second icon. The user may touch the second icon to identify it. The user may then begin a gesture motion, and the direction, distance, and duration of the motion may be evaluated to determine if the motion indicates that the second icon is to be added to the group selection with the first icon. While the second icon is being selected, the first icon may appear that is part of a group selection. Once the second icon is selected, the second icon may also appear to be part of a group selection. For example, the icons may appear highlighted.

Moving to 202, the processor outputs information about a selection group including the first icon and the second icon to an operating system method for group selection. For example, the method for using the group selection may not change due to gesture input being used to identify the selection group to allow the flexibility to create a selection group using gesture input or a keyboard. In some cases, the method for adding the icon to the group may use existing operating system functionality. For example, a selection item may be determined based on gesture input, and an existing operating system method may be called to add the selection item to a group selection. The operating system functionality may be used to perform an operation on the icons within the selection group. For example, the icons may be deleted based on a single delete command from a user without a user providing an individual delete command for each of the icons.

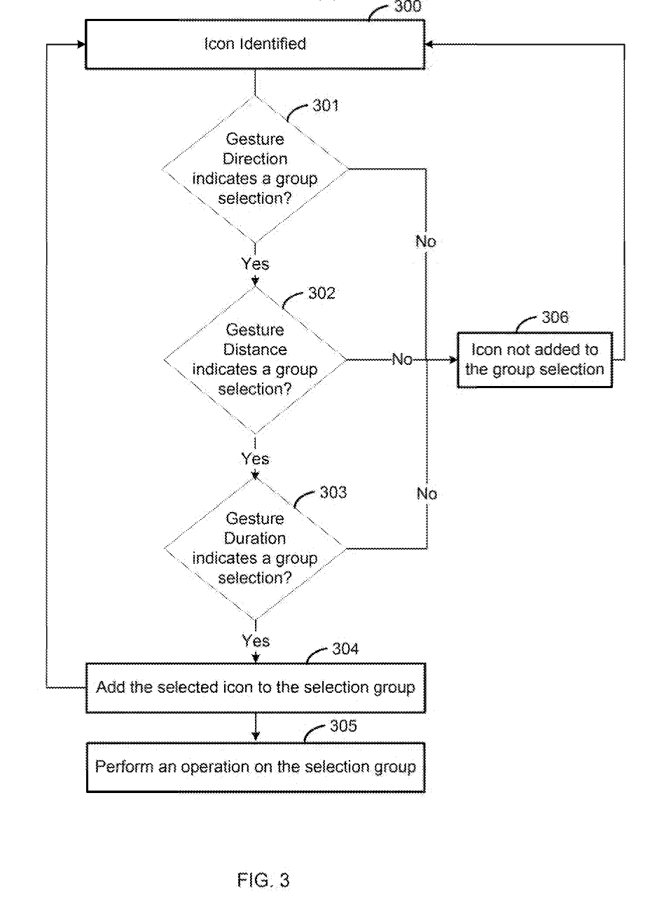

FIG. 3 is a flow chart illustrating one example of determining a group selection based on gesture input. A processor may evaluate the direction, distance, and duration of a gesture input related to an identified icon displayed on a user interface to determine whether to add the selected icon to a selection group. A particular type of gesture may indicate a group selection. The flow chart illustrates an example order for evaluating a gesture input The method may be implemented, for example, by the apparatus 100.

Beginning at 300, a new icon is identified. The icon may be identified based on an input relative to a display, such as where a user touches a display in an area where the icon is displayed or a camera detects a user pointing or making another pose to identify the particular icon on the display. The user input may be associated with grabbing the icon, and a gesture may be performed that is associated with dragging the icon across the display. The gesture may be evaluated to determine if the gesture indicates that the icon is to be added to a group selection.

Moving to 301, a processor determines whether the direction of a gesture input relative to the icon indicates a group selection. A particular gesture motion may indicate a group selection. For example, a gesture that moves towards the bottom of the display may indicate a group selection. The gesture, may include a touch with multiple fingers or two hands moving in front of the display. The gesture may include multiple directions, such as where a check mark type gesture indicates a group selection.

If the gesture input does not indicate a group selection, continuing to 306 the identified icon is not added to the group selection. In some cases, if the gesture does not indicate a group selection, it may indicate another operation, such as an operation on the identified icon, an end to a group selection, or another operation. The identified icon may appear differently when determined not to add it to the group selection. For example, the identified icon may be highlighted or appear to move with the gesture, and the icon may no longer appear to be highlighted or to no longer move across the display if determined that the icon is not to be added to a group selection.

If determined that the direction indicates, the method continues to 302 to determine whether the distance of the gesture input indicates a group selection. A gesture indicating a movement of the icon greater than distance X may indicate that the selected icon is associated with a group selection. A gesture indicating a smaller movement may not be considered a group selection as the gesture may be unintentional. In one implementation, a gesture indicating a movement of the icon greater than a distance Y is not considered a group selection, for example, because the greater distance may indicate a different operation to be performed. If the distance does not indicate a group selection, the method moves to 306 to deselect the identified icon.

If determined that the gesture distance indicates a group, selection, the method proceeds to 303 to determine whether the duration of the gesture input indicates a group selection. For example, a gesture completed within a time less than X seconds may not be considered a group selection, such as because the movement may be unintentional. In one implementation, a gesture duration greater than Y seconds may not be considered a group selection. If not determined that the gesture distance indicates a group selection, the method moves to 306 to deselect the icon.

If determined that the distance of the gesture indicates a group selection, the method continues to 304 to add the icon to the selection group. For example, information about the selected icon may be stored. The icon may appear differently when added to a group selection, For example, the icon may appear to be highlighted. An indication may be provided to user to indicate that the icon is added to the group selection. For example, an audio or visual indication may be provided.

The method may move back to 300 where another icon is identified, a gesture is evaluated to determine if the second icon is to be added to the selection group. The method may continue to allow more icons to be added to the selection group.

In one implementation, an item may be removed from the selection group. Any suitable input may be associated with a removal of an item. For example, repeating the gesture indicating the selection of an item may indicate that the item is de-selected. In one implementation, the group selection may end based on a gesture, such as where another gesture not indicating group selection is performed.

Moving to 305, an operation may be performed on the icons within the selection group. In one implementation, the selection group operation is performed using existing operating system functionality. For example, a group of icons may be selected on a desktop interface, and an operating system method may be called to add the selection group and existing operating system functionality may perform the operation on the selection group.

An operation may be performed on the selection group as whole such that the user may provide a command related to the group. For example, the items in the selection group may be cut, copied, deleted, or moved to a new location based on a single user command. In one implementation, a user input is evaluated to determine to stop adding elements to the group selection. For example, a different input type may be provided indicating that an operation should be performed on the selection group.

1. A method, comprising:
identifying an icon on a user interface based on a position of a user input relative to the user interface; detecting a direction of a gesture input relative to the user interface;
detecting a distance of the gesture input;
detecting a duration of the gesture input; and
determining, by a processor, to add the identified icon to a selection group of icons based on the detected gesture input direction, distance, and duration.

2. The method of claim 1, further comprising performing an operation on the selection group.

3. The method of claim 1, wherein identifying the position of the user input comprises identifying the position based on information from at least one of a resistive, capacitive, or optical sensor.

4. The method of claim 1, further comprising determining to end the selection group based on a gesture input relative to the user interface.

5. The method of claim 1, wherein the user interface comprises a desktop user interface.

6. The method of claim 1, further comprising updating the user interface to indicate the icon added to the selection group.

7. The method of claim 1, wherein determining to add the icon based on the direction of the gesture input comprises determining to add the icon wherein the direction of the gesture input is towards the bottom of the user interface.

8. An apparatus, comprising:
a display;
a sensor to sense a gesture input relative to the display;
a storage to store information about a selection group;
a processor to:
determine a group selection of an identified icon displayed do the display based on information from the sensor indicating duration, distance, and direction of a gesture input relative to the display device; and
add information about the icon to the stored information about the selection group.

9. The apparatus of claim 8, wherein the processor further deletes information about an icon within the selection group based on information from the sensor about a gesture input relative to the display device.

10. The apparatus of claim 8, wherein the processor further performs an operation on the icons within the selection group.

11. The apparatus of claim 8, wherein the processor further outputs an indication that the icon is added to the selection group.

12. A machine-readable non-transitory storage medium comprising instructions executable by a processor to:
determine a selection of a first icon based on a position, distance, duration, and direction of a first gesture input;
determine a selection of a second icon based on a position, distance, duration, and direction of a second gesture input; and
output information about a selection group including the first icon and the second icon to an operating system method for group selection.

13. The machine-readable non-transitory storage medium of claim 13, further comprising instructions to call an operating system method to perform an operation on the selection group.

14. The machine-readable non-transitory storage medium of claim 13, further comprising instructions to delete the first icon from the selection group based on a gesture input.

15. The machine-readable non-transitory storage medium of claim 13, further comprising instructions to determine to end the selection group based on a third gesture input.
